(19) United States
(12) Patent Application Publication
(10) Pub. No.: US 2023/0244006 A1
(43) Pub. Date: Aug. 3, 2023

(54) Manufacturing Of Heterostructured Polymer-Infiltrated Nanoparticle Films Via Capillary Rise Infiltration And Their Applications

(71) Applicant: The Trustees of the University of Pennsylvania, Philadelphia, PA (US)

(72) Inventors: Daeyeon Lee, Wynnewood, PA (US); Baek Min Kim, Kaejeon (KR)

(21) Appl. No.: 18/051,624

(22) Filed: Nov. 1, 2022

Related U.S. Application Data
(60) Provisional application No. 63/274,100, filed on Nov. 1, 2021.

(51) Int. Cl. G02B 1/18; C08J 7/06; G02B 1/00

(52) U.S. Cl. CPC G02B 1/18; C08J 7/06; G02B 1/005; C08J 2325/06

(57) ABSTRACT

Polymer-infiltrated nanoparticle films (PINFs) that have high volume fractions (>50 vol %) of nanoparticles (NPs) possess enhanced properties making them ideal for various applications. Capillary rise infiltration (CaRI) of polymer and solvent-driven infiltration of polymer (SIP) into pre-assembled NP films have emerged as versatile approaches to fabricate PINFs. Although these methods are ideal for fabricating PINFs with homogenous structure, several applications including separations and photonic/optical coatings would benefit from a method that enables scalable manufacturing of heterostructured (i.e., films with variation in structural properties such as porosity, composition, refractive indices etc.) PINFs. In this work, a new technique is developed for fabricating heterostructured PINFs with cavities based on CaRI. A bilayer composed of densely packed inorganic NP layer atop polymer NP layer is thermally annealed above the glass transition temperature of the polymer NP, which induces CaRI of the polymer into the interstices of the inorganic NP layer. Exploiting the difference in the sizes of the two particles, heterostructured double stack PINFs composed of a PINF and a layer with large cavities are produced at a moderate temperature (<200° C.). Using these heterostructured PINFs, Bragg reflectors that can detect the presence of wetting agents in water are fabricated.

### RELATED APPLICATIONS

The present application claims priority to and the benefit of U.S. Patent Application No. 63/274,100, “Manufacturing Of Heterostructured Polymer-Infiltrated Nanoparticle Films Via Capillary Rise Infiltration And Their Applications” (filed Nov. 1, 2021), the entirety of which is incorporated herein by reference for any and all purposes.

### GOVERNMENT RIGHTS

This invention was made with government support under 1720530 awarded by the National Science Foundation. The government has certain rights in the invention.

### TECHNICAL FIELD

The present disclosure relates to the field of nanoparticulate films.

### BACKGROUND

Infiltrating a polymer into a film of densely packed nanoparticles (NPs) has emerged as a powerful method of fabricating a nanocomposite film with an extremely high volume fraction (well above 50 vol %) of NPs. This approach circumvents several challenges associated with preparing highly loaded nanocomposite films using conventional methods such high viscosity and elasticity of polymer-NP mixtures as well as incompatibility between NPs and polymer. Moreover, polymer-infiltrated NP films (PINFs) with highly anisotropic particles such as nanowires and nanoellipsoids can be readily fabricated, e.g., in a scalable way. High volume fractions of NPs in PINFs lead to unique properties that make them useful in various applications. For example, they have been applied to membranes or working electrodes in energy devices, separation membranes, antireflection and super hydrophobic films, and microwave attenuators.

Infiltration of polymers into the interstices of the NP films can be achieved using several methods including immersion of the NP films in polymer melts or solutions, exposure of the NP films to monomers that are subsequently polymerized in situ, and filling the NP films with resins that are cross-linked afterward. More recently, methods to directly infiltrate polymers into NP films via capillary rise infiltration (CaRI) and solvent-driven infiltration of polymer (SIP) have been developed. In the case of the CaRI technique, a bilayer film, which is composed of a dense NP layer and a polymer layer, is heated above glass transition temperature (T_{g}) of the polymer such that the polymer infiltrates into the nanopores of the NP layer via nanowicking. Instead of thermal annealing, the SIP technique takes advantage of solvent annealing. By exposing a bilayer film to solvent vapor, the solvent is condensed in the nanopores by capillarity, and then plasticizes the polymer to induce its infiltrate into the nanopores.

Although these techniques are able to produce PINFs with extremely high-volume fraction (>60 vol %) of NPs in scalable and controllable manner, these methods are suited for making homogeneous PINFs that have uniform composition and structure through the thickness. For a number of applications that involve nanocomposite materials, however, heterostructured PINFs that have varying structures and/or properties in the thickness directions are useful and at times near-essential. For example, several optical and photonic coatings take advantage of variations in refractive index (n) of the structure to facilitate constructive/destructive interference of light. Moreover, many separation membranes take advantage of asymmetric structures that are composed of a thin layer with very low porosity and a thick layer with high porosity. Also heterostructured films have shown to be useful in controlled delivery of active agents to control cellular behavior. Accordingly, there is a need in the art for heterostructured films and methods of making such films.

### SUMMARY

To enable manufacturing of heterostructured PINFs, we present an organic solvent-free technique that uses two different aqueous dispersions of NPs. One dispersion comprises inorganic NPs, whereas the other one is made of polymer NPs. As schematically illustrated in FIG. 1, by sequentially depositing these two NPs, the initial bilayers for CaRI are formed. Depending on the structure of initial bilayers, the PINFs with different mesoscopic structures are generated upon thermal annealing. In particular, when polymer NPs and inorganic NPs form the under- and upper-layer of the bilayer, respectively, heterostructured PINFs with cavities in the lower layer are obtained. As one example application of such a double stack structure with cavities, we fabricate Bragg reflectors that are able to detect presence of wetting agents in water.

In meeting the described long-felt needs, the present disclosure provides heterostructured films having a thickness, comprising: at least one section (which section can be a repeat unit), the at least one section comprising a first region defined along the direction of the thickness, the first region comprising a plurality of cavities therein, the cavities being defined between struts that comprise template particles having interstitial spaces therebetween that are infiltrated by a filler polymer having a glass transition temperature or a melting temperature, and a second region defined along the direction of the thickness, the second region being adjacent to the first region, and the second region being formed of template particles having interstitial spaces therebetween that are infiltrated by the filler polymer.

Also provided are Bragg reflectors, the Bragg reflector comprising a heterostructured film according to the present disclosure, e.g., one of Embodiments 1-7.

Further disclosed are layered compositions, comprising: a first layer of polymeric particles, the polymeric particles optionally being disposed in a liquid dispersion, the polymeric particles defining an average cross-sectional dimension and having a glass transition temperature or a melting temperature; and a first layer of template particles, the template particles optionally being inorganic particles, the template particles optionally being disposed in a liquid dispersion, the template particles defining interstitial voids therebetween, the template particles defining an average cross-sectional dimension that is less than the average cross-sectional dimension of the polymeric particles, and the first layer of template particles optionally being disposed atop the first layer of polymeric particles.

Also disclosed are methods, comprising: annealing a layered composition according to the present disclosure (e.g., one of Embodiments 9-18) at a temperature above the glass transition temperature or the melting temperature of the polymer particles such that polymer of the polymer particles infiltrates into the interstitial voids between the template particles so as to give rise to a film having a thickness and the film being characterized as homogeneous along the direction of the thickness.

Further provided are methods, comprising: annealing a layered composition according to the present disclosure (e.g., any one of Embodiments 9-18) at a temperature above the glass transition temperature or the melting temperature of the polymer particles such that polymer of the polymer particles infiltrates into the interstitial voids between the template particles so as to give rise to a film having a thickness and the film being characterized as heterogeneous along the direction of the thickness, the film defining a first region along the direction of the thickness, the first region being polymer of the polymeric particles, the film defining a second region along the direction of the thickness, the second region adjacent to the first region and the second region being template particles having interstitial spaces therebetween that are infiltrated by the polymer of the polymeric particles, and the film defining a third region along the direction of the thickness, the third region being adjacent to the second region and the third region being template particles. Such a film can be characterized as a trilayer film.

Also disclosed herein are methods, comprising: annealing a layered composition according to the present disclosure (e.g., any one of Embodiments 9-18) at a temperature above the glass transition temperature or the melting temperature of the polymer particles such that polymer of the polymer particles infiltrates into the interstitial voids between the template particles so as to give rise to a film having a thickness and the film being characterized as heterogeneous along the direction of the thickness, the film defining a first region along the direction of the thickness, the first region comprising a plurality of cavities therein, the cavities being generally located at locations occupied by the polymer particles before annealing and the cavities being defined between struts comprising template particles having interstitial spaces therebetween that are infiltrated by the polymer of the polymeric particles, the film defining a second region along the direction of the thickness, the second region adjacent to the first region and the second region being template particles having interstitial spaces therebetween that are infiltrated by the polymer of the polymeric particles.

Also provided are homogeneous films made according to the present disclosure, e.g., according to Embodiment 19.

Further provided are heterogeneous films made according to the present disclosure, e.g., according to any one of Embodiments 20-21.

Additionally disclosed are methods, comprising: with

(a) a layer of template particles, the template particles optionally being inorganic particles, the template particles optionally being disposed in a liquid dispersion, the template particles defining interstitial voids therebetween, and the template particles defining an average cross-sectional dimension that is less than the average cross-sectional dimension of the polymeric particles, and

(b) a layer of polymeric particles, the polymeric particles optionally being disposed in a liquid dispersion, the polymeric particles defining an average cross-sectional dimension and having a glass transition temperature or a melting temperature, and the layer of polymeric particles being located adjacent to and beneath the layer of template particles;

annealing the layer of polymeric particles so as to give rise to a heterostructured film having a thickness,

the heterostructured film defining a first region along the direction of the thickness, the first region comprising a plurality of cavities therein, the cavities being generally located at locations occupied by the polymer particles before annealing the polymeric particles and the cavities being defined between struts comprising template particles having interstitial spaces therebetween that are infiltrated by the polymer of the polymeric particles, the heterostructured film defining a second region along the direction of the thickness, the second region adjacent to the first region, and the second region being template particles having interstitial spaces therebetween that are infiltrated by the polymer of the polymeric particles.

Also disclosed are methods, comprising: dispersing a mixture of (i) polymeric particles having a glass transition temperature or a melting temperature and (ii) template particles in an evaporative medium across a substrate, the dispersing being performed under such conditions that evaporation of the evaporative medium gives rise to stratification between the template particles and polymeric particles such that the polymeric particles form a lower layer atop which the template particles form an upper layer; and annealing the lower layer and the upper layer so as to give rise to a film having a thickness and the film being characterized as heterogeneous along the direction of the thickness, the film defining a first region along the direction of the thickness, the first region comprising a plurality of cavities therein, the cavities being generally located at locations occupied by the polymer particles before annealing and the cavities being defined between struts comprising template particles having interstitial spaces therebetween that are infiltrated by the polymer of the polymeric particles, the film defining a second region along the direction of the thickness, the second region adjacent to the first region and the second region being template particles having interstitial spaces therebetween that are infiltrated by the polymer of the polymeric particles.

Without being bound to any particular theory, the present inventors discovered that, inter alia, by selection of particle sizes such that small particles can occupy the space in between larger particles, upon thermal annealing can give rise to heterostructured films, including such films that include cavities present therein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: Schematic illustration describing the process to fabricate PINFs by CaRI with two example NPs.

FIGS. 2A-2C: Illustrate cross-section and top-down SEM images of the bilayers for CaRI with 26 nm SiO₂ and 100 nm PS NPs, before (left) and after (right) annealing at 180° C. for 3 hr; sequentially spin coated bilayers with (FIG. 2A) PS NP layer atop the SiO₂ NP layer (100 nm PS/150 nm SiO₂), and with (FIG. 2B) SiO₂ NP layer atop the PS NP layer (90 nm SiO_{2/100} nm PS). FIG. 2C—One-step blade coated bilayer with the SiO₂ NP layer atop the PS NP layer (80 nm SiO_{2/100} nm PS). In FIG. 2A and FIG. 2B, the refractive index of each layer is obtained from spectroscopic ellipsometry. The refractive indices of pure SiO₂ and PS are 1.46 and 1.59, respectively. All scale bars are 100 nm.

FIG. 3: Changes in the thicknesses of the neat PS layer, PS-infiltrated SiO₂ layer, and neat SiO₂ layer as a function oft measured using in situ spectroscopic ellipsometry at 140° C. (upper part) for (100 nm PS/150 nm SiO₂) bilayer, and cross-section SEM images taken at different times points (lower part). T was raised from room temperature (≈20° C.) to 140° C. at a rate of 30° C.·min⁻¹, and then maintained at 140° C. To observe the structures over t with SEM images, the films are quenched at desired ts. All scale bars are 100 nm.

FIG. 4: Cross-section SEM images of the heterostructured PINFs made via CaRI with SiO₂ and PS NPs at some featured as (upper part) and dependence on a of refractive index of each layer (lower part). The solid black lines represent the expected values of refractive indices based on the volume fractions of the SiO₂ and PS NPs upon completion of CaRI, and the markers indicate measured values from the spectroscopic ellipsometry. All scale bars are 100 nm.

FIGS. 5A-5D: Cross-section SEM images and top-down optical images of a multilayer with five alternating SiO₂ and PS NP layers (FIG. 5A) before and (FIG. 5B) after annealing. (FIG. 5C) Top-down optical images of the green Bragg reflectors (N=7) in air, water and ethanol, and (FIG. 5B) their transmittance spectra in ethanol-water mixtures of various compositions. Slightly different appearance in the corners of the Bragg reflectors are due to the thicker rim that forms during spin coating. All scale bars for the optical images are 1 cm.

FIG. 6: Cross-section SEM images of a (SiO₂/PS) bilayer made with 110 nm SiO₂ and 100 nm PS NPs before and after annealing. SiO₂ NPs are not small enough to infiltrate into the voids between PS NPs. Accordingly, after thermal annealing, the overall thickness is reduced to the thickness of the SiO₂ layer, leading to a single layer homogeneous PINF rather than a double stack PINF.

FIG. 7: Cross-section SEM images of a (SiO₂/PS) bilayer made with 26 nm SiO₂ NPs and 1 μm PS particles before and after annealing.

FIG. 8: A state diagram of dynamic self-stratification of 26 nm SiO₂ NP and 100 nm PS NP. The red line is obtained from β²(1+Peₛₘₐₗₗ)ϕₛₘₐₗₗ=1, where β is particle size ratio (>1) and ϕₛₘₐₗₗ is volume concentration of SiO₂ NP in dispersions, and the blue line is obtained from Peₛₘₐₗₗ=1/β.

FIG. 9: Imperfect (SiO₂/PS) stratification by blade coating.

FIG. 10: Refractive indices of (PS/SiO₂) bilayers upon completion of CaRI. When α>1, the nanopores become saturated with PS, and surplus PS remains as a residual layer on top (SEM image at α≈1.31). Since PS NPs have undergone coalescence, the refractive index of the PS layer (∇) is the same as that of bulk PS. In contrast, when α<1, the nanopores are under-saturated with PS with no remaining PS layer (SEM image at a≈0.77). The resulting CaRI PINFs nevertheless have homogeneous structures because PS spreads uniformly throughout the nanopores via surface diffusion, consistent with prior study. The solid black lines, representing the expected values of refractive indices based on the volume fractions of the PS and SiO₂ NPs upon completion of CaRI, agree well with the experimentally measured refractive indices (▾) obtained based on spectroscopic ellipsometry. Refractive index calculations for PINFs made via CaRI with SiO₂ and PS NPs.

FIG. 11: Transmittance spectra of multilayers (N=5) before and after annealing, and annealed multilayers depending on Ns. The intensity of the reflectance band (R) for Bragg reflectors with quarter-wavelength stacks depends on the refractive indices of the two stacks as well as N as expressed by,

$$R = {( \frac{1 - Y}{1 + Y} )}^{2} \times 100 ( \% ) , Y = {( \frac{{n}_{H}}{{n}_{L}} )}^{N - 1} \times \frac{{n}_{H}^{2}}{{n}_{S}} ,$$

where n_{H}, and n_{L} are the refractive indices of the high and low index layers, respectively, n_{S} is that of the substrate. Consistent with the equation, the intensity of the transmittance band decreases from 76% to 46% as N is increased from five to nine. The transmittance spectra are measured for the multilayers deposited on glass slides.

FIG. 12: Transmittance spectra and top-down optical images (inset) of the annealed multilayers (N=7), with varying α. Bragg reflectors with major reflectance band in the blue (λ≈480 nm), green (λ≈560 nm) and red (λ≈680 nm) regions of the spectrum are produced as the high index region thickness is changed from 70, 100 and 130 nm, respectively. The transmittance intensity decreases as the band moves to higher λs since the difference in the refractive index decreases due to smaller αs. The transmittance spectra are measured for the multilayers deposited on glass slides. All scale bars for the optical images are 1 cm.

FIG. 13: Transmittance spectra of glass slides in ethanol-water mixtures of various proportions.

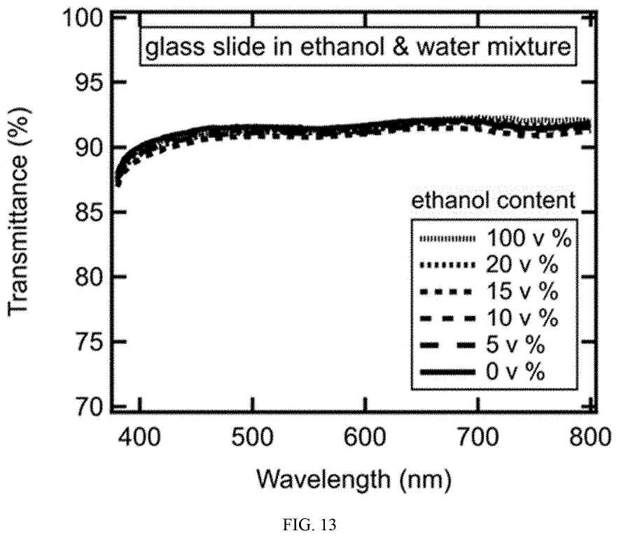

FIGS. 14A-14B: Transmittance spectra of the green Bragg reflectors (N=7) in (FIG. 14A) dimethyl sulfoxide (DMSO)-water and (FIG. 14B) acetonitrile-water mixtures of various compositions.

FIG. 15. Annotated illustration of a film according to the present disclosure.

FIG. 16. Annotation depiction of a film according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### Example Results & Discussion

Homogenous and Heterostructured PINFs Via Sequential Spin Coating and CaRI

To perform organic solvent-free CaRI with inorganic and polymer NPs, 26 nm SiO₂ NP and 100 nm polystyrene (PS) NP aqueous dispersions are used unless otherwise noted. Two NPs are sequentially spin coated on a silicon (Si) wafer to form a bilayer, which is subsequently heated at 180° C. (>T_{g} of PS 100° C.) for 3 hr to induce CaRI of PS into the nanopores of the SiO₂ NP layer. We will use the following nomenclature to describe the initial bilayer: (thickness Sift/thickness PS); for example, (150 nm SiO_{2/100} nm PS) indicates that 150 nm thick layer made of disordered packing of 26 nm SiO₂ NPs is deposited atop a 100 nm thick layer of 100 nm PS NPs. The changes in the structure and optical properties of the bilayer upon CaRI are characterized based on (in situ) ellipsometry and scanning electron microscopy (SEM).

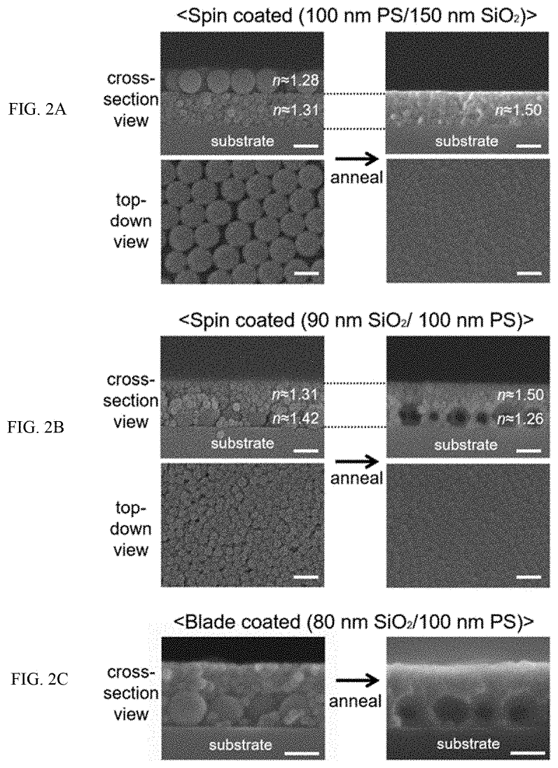

When PS NPs are spin coated atop a SiO₂ NP layer, the larger PS NPs do not infiltrate into the interstices of the SiO₂ NP layer during the spin coating process, leading to the formation of a bilayer with each layer consisting of exclusively SiO₂ or PS NPs as shown in FIG. 2A. To control the extent of infiltration, we define the ratio of the volume of PS NPs over that of the interstitial voids in the SiO₂ layer as the fill ratio, a. The thickness of each layer composing the bilayer is controlled to meet α≈1 so that there would be no residual PS NPs or unfilled nanopores upon completion of CaRI. Based on spectroscopic ellipsometry, the solid volume fractions (ϕ) in the PS and SiO₂ layers are ϕ_{PS} 48 vol % and ϕ_{SiO2} 68 vol %, respectively; thus 100 nm PS NP layer atop 150 nm SiO₂ NP layer gives α≈1 as described elsewhere herein.

Upon thermal treatment, the overall thickness of the bilayer is reduced to that of the SiO₂ layer (FIG. 2A), which implies the complete infiltration of PS into the nanopores of the SiO₂ layer has occurred. Both the cross-section and the top-down SEM images confirm the formation of SiO₂ NP layer that is fully infiltrated with PS (FIG. 2A). The refractive index of the annealed CaRI film is consistent with complete filling of pores with PS; that is, the annealed CaRI film consists of 32 vol % of PS and 68 vol % of SiO₂.

Furthermore, we characterize the structure of CaRI films when the sequence of spin coating is reversed; that is, 100 nm PS NPs are spin-coated first, followed by 26 nm SiO₂ NPs. In such a case, some of SiO₂ NPs infiltrate into the voids of the PS NP layer during spin coating. The thickness of each layer is adjusted to meet α≈1; 100 nm PS NP layer (monolayer) and 90 nm thick SiO₂ layer (i.e., 90 nm SiO₂/100 nm PS) satisfies α≈1. Because some SiO₂ NPs fill the voids of the PS NP layer, the thickness of the SiO₂ layer in this case is thinner than the thickness required to give α≈1 when SiO₂ NP is spin coated first. In short, after the deposition of SiO₂ NPs, the PS NP layer becomes a ternary layer composed of 50 vol % PS NPs, 28 vol % SiO₂ NPs and 22 vol % of voids, whereas the SiO₂ layer comprises 68 vol % SiO₂ NPs and 32 vol % air.

FIG. 2B shows cross-section and top-down SEM images of a (90 nm SiO_{2/100} nm PS) bilayer before and after thermal treatment. In the cross-section view, it can be seen that SiO₂ NPs are packed in the voids of the PS NP layer. In contrast to the (100 nm PS/150 nm SiO₂) bilayer, the overall thickness of the film does not change after CaRI has taken place. Instead, cavities are observed in the bottom part of the resulting film where the PS NP layer used to be, and the size of cavities matches that of the PS NP. These results indicate that PS has infiltrated into the interstices between SiO₂ NPs that are in the upper layer as well as in the voids between PS NPs. The struts between cavities are sufficiently robust to maintain the overall structure. Unlike conventional methods that rely on high temperature (typically >300° C.) removal of sacrificial materials such as porogens, this method enables generation of cavities in nanocomposite films using a moderate temperature process (<200° C.). The refractive indices of the bottom layer with cavities and fully infiltrated upper layer are 1.26 and 1.50, respectively, and agree well with the estimation.

Other work has shown that many types of polymers infiltrate packing of SiO₂ NPs via capillarity due to the high surface energy of SiO₂. Thus, particles made of a wide range of linear polymers can be used to form heterostructured PINFs with cavities using the disclosed approach. Without being bound to any particular theory or embodiment, the size of the smaller inorganic NPs can be small enough to slide into the interstices between the larger polymer particles to enable the formation of the heterostructured PINFs with cavities. Given that the average pore size in random close packing of spheres is estimated to be approximately 30% of the particle size, the size of the smaller particles can be, e.g., less than 30% of that of the larger particles. As but some examples, the smaller particles can have a diameter that is, on average, from about 0.01 to about 30% of the diameter of the larger particles, or from about 0.05 to about 27% of the diameter of the larger particles, or from about 0.1 to about 26% of the diameter of the larger particles, or from about 0.8 to about 21% of the diameter of the larger particles, or from about 1.7 to about 18% of the diameter of the larger particles, or from about 2.9 to about 14% of the diameter of the larger particles, or from about 5 to about 10% of the diameter of the larger particles. The smaller particles can have a diameter that is, on average, less than about 30% of the diameter of the larger particles, or less than about 29, 28, 27, 26, 25, 24, 23, 22, 21, 20, 19, 18, 17, 16, 15, 14, 13, 12, 11, 10, 9, 8, 7, 6, 5, 4, 3, 2, or even 1% of the diameter of the larger particles.

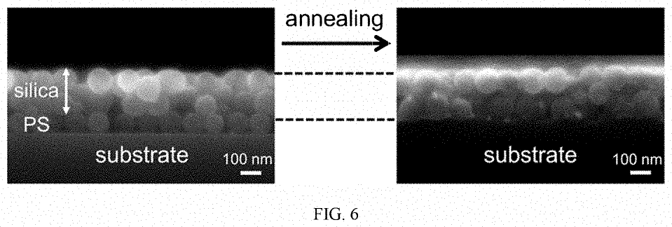

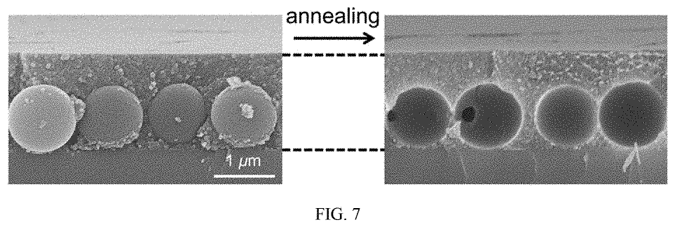

When the size of SiO₂ (or other inorganic) NPs is not small enough to slide into the voids of the PS NP layer, homogeneous PINFs like the one observed in FIG. 2A are obtained rather than the heterostructured PINFs after annealing, as shown in FIG. 6. However, as long as the size of SiO₂ NPs is small enough, this method can be extended easily to micrometer scale PS particles as shown in FIG. 7. It should be understood that the SiO₂/PS system described herein is illustrative only and does not limit the scope of the present disclosure or the appended claims.

Heterostructured PINFs Via One-Step Blade Coating and CaRI

As an approach to form the initial bilayers for organic solvent-free CaRI with inorganic and polymer NPs, we test blade coating with a mixture of SiO₂ and PS NPs. By dragging meniscus of dispersions using a blade, a thin uniform dispersion film can be formed and uniform evaporation of the solvent can be induced. Moreover, blade coating is a highly scalable manufacturing method because films can be produced continuously with little loss of the dispersion.

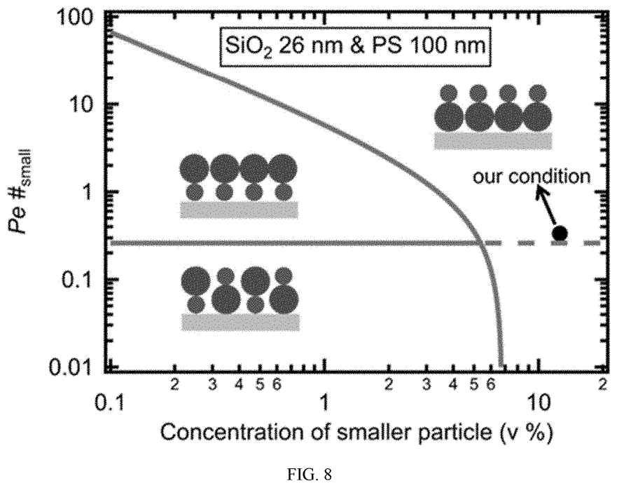

Several prior reports have investigated the self-stratification of particles of two different sizes during evaporation of the medium. A recent study, which accounts for the cross interactions between particles, provides a robust guideline on how to achieve stratification of two NPs based on the concentration of the smaller particle (in our case, SiO₂ NP) and the Peclet number (Pe), defined as ratio of the evaporation rate of solvent to the diffusion rate of particles:

$$Pe = \frac{evaporation rate}{diffusion rate} = \frac{{v}_{ev}}{D / H} = \frac{6 π η {av}_{ev} H}{{k}_{B} T} , \qquad ( 1 )$$

where vₑᵥ is the evaporation rate, D is the diffusion constant of particles, H is dispersion height, η is dynamic viscosity, and a is radius of particles, k_{B} is Boltzmann constant, and T is temperature. Based on the modeling presented Ref, we prepare a state diagram of self-stratification as a function of the Pe and the concentration of the of the smaller (SiO₂) NP which shows criteria leading the two lanes of self-stratification (FIG. 8).

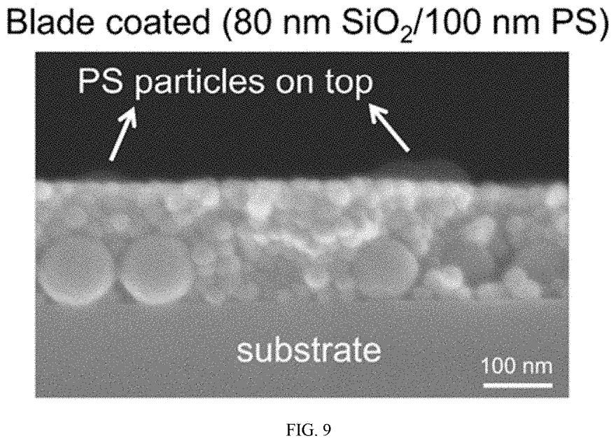

To achieve a (SiO₂/PS) bilayer, we mix SiO₂ NPs and PS NPs at concentrations of 12 vol % and 4 vol %, respectively, and blade coat the mixed suspension at 50° C. which gives Peₛₘₐₗₗ≈0.3. The deposited film shows mostly clear stratification with a (SiO₂/PS) bilayer structure as shown in FIG. 2C. While blade coating provides one-step process, the quality of stratification is slightly inferior to that of spin coating. As shown in FIG. 9, some PS particles are found in the top layer; without being bound to any particular theory or embodiment, these imperfections in stratification may be due to adsorption of PS particles to the evaporating air/water interface, preventing their migration to the bottom layer. Upon thermal annealing at 180° C. for 3 hr, the bilayer turns into the double stack PINFs (FIG. 2C) which resembles the double stack PINF that is produced via CaRI of a sequentially spin coated (SiO₂/PS) bilayer (FIG. 2B). To prepare a (PS/SiO₂) bilayer with, the concentration of the SiO₂ NPs has to be kept below 5 vol %, according to the state diagram. At such concentrations, the SiO₂ NP layer produced via blade coating ends up being too thin to induce dynamic self-stratification. Blade speed has to be changed to produce a SiO₂ NP layer that is more than a few particle layer thick; however, such a change can increase H by only 2-3 times. Thus, blade coating is better suited for preparing bilayers with SiO₂ NP layer atop PS NP layer in one step which subsequently can be annealed to produce double stack PINF with caivities in the bottom layer.

Dynamics of CaRI with Inorganic and Polymer NPs

We monitor the changes in the thickness and refractive index of a (100 nm PS/150 nm SiO₂) bilayer upon thermal annealing using an ellipsometer, and the changes are modeled using the Cauchy model (see details elsewhere herein). Once the infiltration of PS into the SiO₂ NP layer is initiated, the bilayer becomes a trilayer comprising a neat PS layer, a PS-infiltrated SiO₂ layer and a neat SiO₂ layer; thus, we use a three-layer Cauchy model to describe the changes in the structure during CaRI.

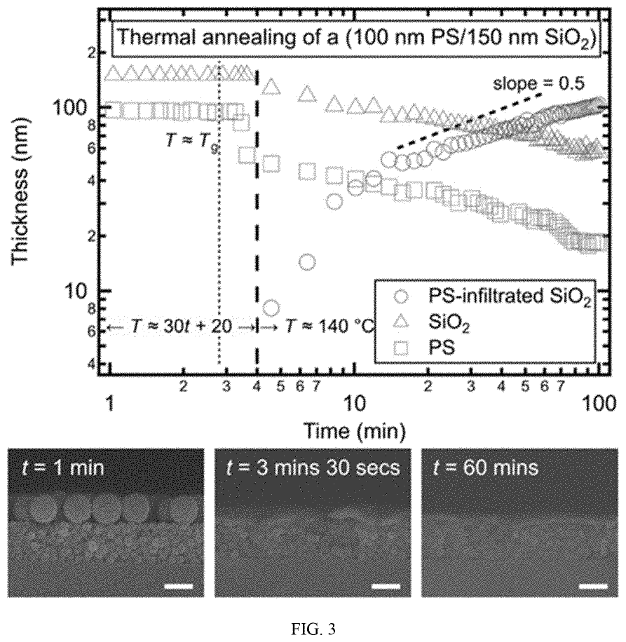

FIG. 3 presents time dependent changes in thickness of each layer and cross-section SEM images of quenched films at different time points during CaRI. To initiate CaRI, the temperature of the sample is raised from room temperature (≈20° C.) to 140° C. at a rate of 30° C.·min⁻¹, and then is maintained at 140° C. Once the temperature of the sample reaches and goes above the glass transition temperature (T_{g}≈100° C.) of PS (t=3 min), the thickness of the neat PS NP layer decreases by about half, which implies the coalescence and merging of fluidized PS NPs; the initial ϕ of the PS NP layer is 48 vol %, which is consistent with the thickness change. Cross-sectional SEM images of the sample at t=3.5 min also show the decrease of the thickness, and the loss of particle morphology.

At 140° C., infiltration of fluidized PS into the SiO₂ layer starts. The thickness of the PS-infiltrated SiO₂ layer increases depending on t with a power close to 0.5, which agrees well with the Lucas-Washburn equation,

$${h}^{2} = \frac{σ r cos {θ}_{c}}{4 {τ}^{2} η} t , \qquad ( 2 )$$

where h is height of liquid rise, a is surface tension, r is mean porous radius, θ_{ca} is contact angle, and τ is tortuosity of porous network. This trend is consistent with previous CaRI studies. In addition, the sum of the thickness of the neat SiO₂ layer and PS-infiltrated SiO₂ layer is almost the same with the initial thickness of the SiO₂ layer (≈150 nm), indicating that the infiltration does not affect the structure SiO₂ layer. Thus, the ϕ of the SiO₂ NPs remains high during and after the infiltration of the PS.

Controlling Refractive Index of PINFs Made Via CaRI with Inorganic and Polymer NPs

The refractive index of an optically transparent film is a useful property of the film that determine its interaction with light. By controlling the refractive index of a film, one can produce optically and photonically active materials such as antireflection coatings and Bragg reflectors with structural color. The refractive index of CaRI PINFs can be controlled by varying what fraction of nanopores is filled with the infiltrating polymers; without being bound by any particular theory or embodiment, upon polymer infiltration, the air void is replaced by the polymer, and thus the refractive index of the film increases accordingly. To control refractive index of the example CaRI PINFs with PS and SiO₂ NPs, we adjust the extent of the infiltration by changing α.

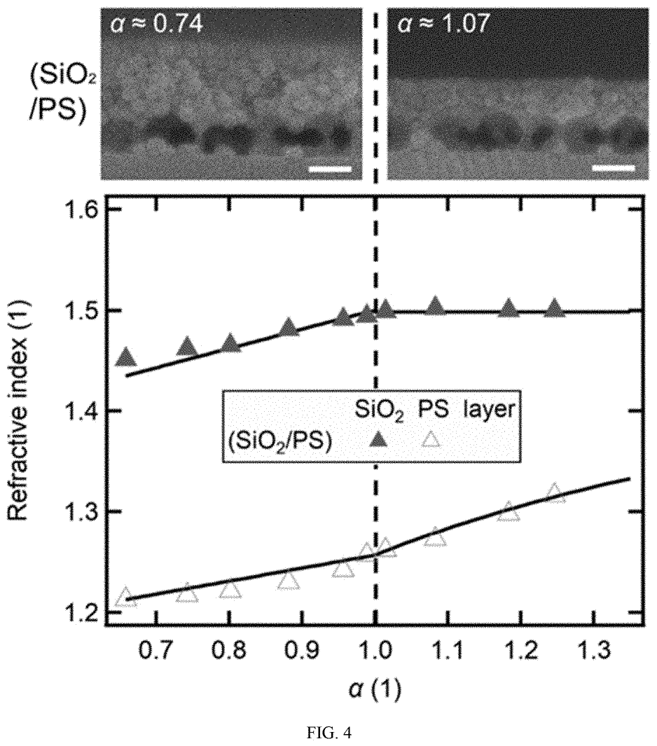

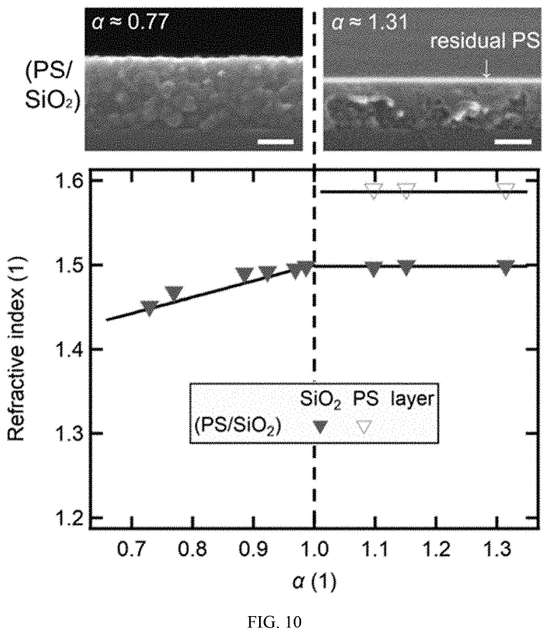

The refractive index of the CaRI PINFs can be precisely controlled by varying α, which we achieve by simply changing the thickness of the SiO₂ layer while keeping the thickness of the PS NP layer constant (≈100 nm). FIG. 4 presents the refractive indices of (SiO₂/PS) bilayers upon completion of CaRI; the refractive indices of (PS/SiO₂) bilayers are presented in FIG. 10. CaRI of (SiO₂/PS) bilayers leads to formation of double stack CaRI PINFs with large cavities in the bottom layer, regardless of α as shown in FIG. 4. When α<1, no residual PS remains in the bottom layer and the SiO₂ top layer is partially infiltrated with PS. The refractive index of the PS-infiltrated SiO₂ layer (▴) depends on a. When α>1, the top SiO₂ NP layer is fully infiltrated with PS. Although it is difficult to directly observe residual PS in the bottom layer, the presence of residual PS can be confirmed from an increase in refractive index of the bottom layer (∇) with α; a larger α gives a higher refractive index, indicating a larger volume of residual PS. The solid black lines, representing the expected values of refractive indices based on the volume fractions of the PS and SiO₂ NPs upon completion of CaRI, agree well with the experimentally measured refractive indices (▴, ∇). Over a wide range of α(0.65-1.35), a large difference in the refractive indices of the two layers (≈0.2) is obtained, which inspires us to use these structures to prepare Bragg reflectors.

Application of the Heterostructured PINFs with Cavities as Bragg Reflectors

Taking advantage of the large difference in the refractive indices of the two stacks in the double stack CaRI PINFs, we fabricate Bragg reflectors that are one-dimensional photonic crystals formed from multilayers of alternating materials of high and low refractive indices. Constructive interference of reflected light from each boundary between high and low index regions combine to give a strong reflectance band at a particular wavelength. The intensity and location of the reflectance band can be controlled by three structural parameters: Difference in the refractive indices, the thicknesses of layers and the total number of layers (N). The reflectance spectrum of a Bragg reflector can be modeled using a transfer matrix method using these three parameters. When the optical thickness (product of refractive index and physical thickness of each layer) is quarter wavelength of visible light, the reflectance band appears in the visible region, resulting in angle-dependent structural color. Bragg reflectors have a wide range of advanced applications as sensors, energy conversion materials and optical filters.

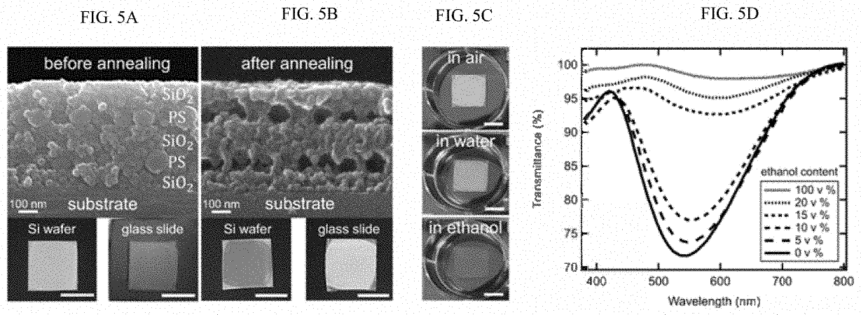

We sequentially spin coat SiO₂ and PS NP layers to form multilayers (N=5-9), and thermally annealed them at 180° C. for 3 hr. The thickness of each layer is controlled to be 100 nm which would give a strong reflectance band around wavelength (λ)=520 nm (green) based on the matrix method simulation. FIG. 5A and FIG. 5B show cross-section SEM images and top-down optical images of a multilayer with five alternating layers before and after annealing, respectively. After annealing, the cavities are created where the PS NPs were initially located, and the resultant structure has the alternating stacks of high and low refractive indices. α of this PINF as approximated by the structure of (150 nm SiO₂/100 nm PS) is 0.68. According to FIG. 4, the refractive indices of the high and low index layers are 1.44 and 1.22 at α=0.68, respectively, giving refractive index different of 0.22. The Bragg reflector deposited on a glass slide glows green as expected, whereas the one deposited on a Si wafer glows purple due to the reflected light from the Si wafer interfering with the reflected light from the Bragg reflector.

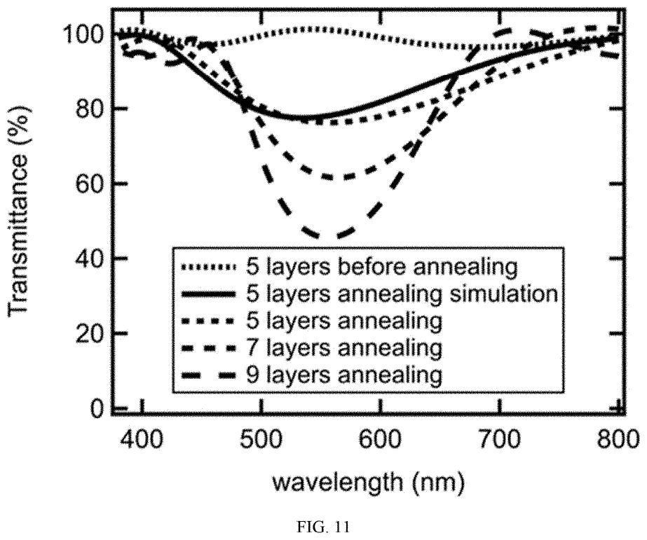

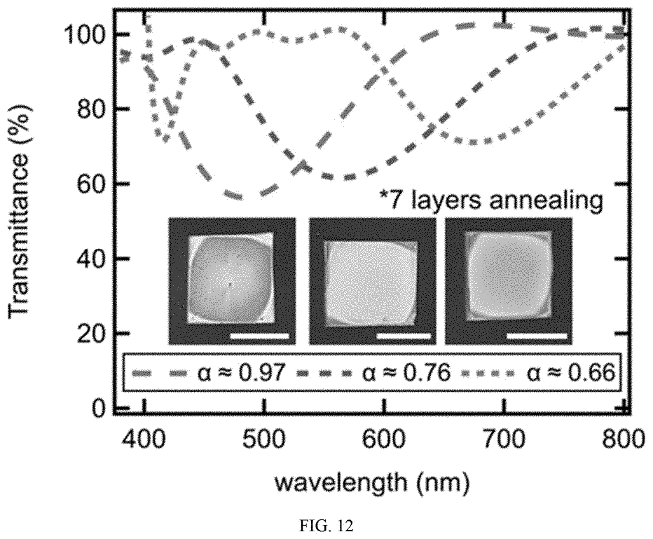

The color appearance of the Bragg reflector undergoes a significant change upon heating the initially prepared multilayer film. To quantify the reflectance band, we measure the transmittance [1−transmittance (%)=reflectance (%)] spectra of the Bragg reflector deposited on a glass slide using the spectrophotometer as shown in FIG. 11. Before annealing, the transmittance spectrum of the initial multilayer film does not exhibit any prominent band; however, after annealing a reflectance band at λ=550 nm with transmittance of ≈76% is observed, which is in good agreement with the simulated spectrum. The small discrepancy between the experimental and calculated spectra could be due to the roughness of the interfaces between the high and low index stacks within the Bragg reflector. The intensity and color of the Bragg reflectors can be adjusted by changing N and the thickness of the layers, respectively as shown in FIGS. 11 and 12.

The formation of cavities in the low refractive index stacks due to CaRI of PS into the SiO₂ layers provides an opportunity to fill these cavities with another medium, e.g., a fluid. The cavities can also be filled by a fluid that is then at least partially solidified, e.g., a further polymer that is then polymerized while occupying the voids. Such a process can change the refractive index of the low index layer, enabling tuning of the optical properties of the Bragg reflectors. In particular, if the cavities are filled with an appropriate liquid that diminishes the difference in the refractive indices of the two stacks, the Bragg reflectors can completely lose the reflection and become transparent.

We exploit this feature to detect presence of wetting agents in water. We take advantage of the fact that PS fills the interstices between SiO₂ NPs and covers the surface of the cavities, rendering the internal surfaces of the Bragg reflector highly hydrophobic which makes it difficult for water to fill these cavities. In fact, the Bragg reflector is not breached by water infiltration under immersion at least for a week. In contrast, water-soluble organic reagents such as ethanol can fill these cavities readily. Thus, we characterize the change in the reflectance of a 7-layered Bragg reflector by immersing it in water-ethanol mixtures. As can be seen in FIG. 5C, while immersion of the Bragg reflector in water does not cause any noticeable changes in its color, immersion in ethanol leads to loss of the reflection. The Bragg reflector immersed in ethanol reverts back to its original state upon complete ethanol evaporation (≈3 sec with nitrogen purge). Moreover, even after immersion in ethanol for a week, the transmittance spectra (FIG. 5D) of the Bragg reflector return to the original state upon ethanol evaporation. These results suggest that the Bragg reflector is very stable and can be used repeatedly.

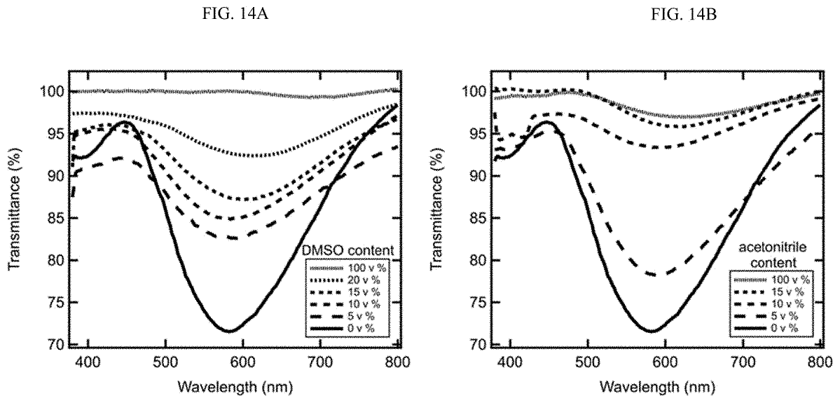

The photonic property of the Bragg reflector depends strongly on the liquid infiltration into the cavities. As can be seen in FIG. 5D, the intensity of transmittance band strongly depends on the concentration of ethanol in the water-ethanol mixtures, implying that the refractive index difference decreases due to the liquid infiltration. Interestingly, an abrupt change in the intensity of transmittance is observed between 10 and 15 vol %. Prior studies have shown that for water-ethanol mixtures, the contact angle transition from non-wetting (>90°) to partially wetting (<90°) states for some hydrophobic surfaces occurs around ethanol concentration of 15 vol %. In fact, contact angle for a neat PS film at ethanol concentration of 15 vol % is smaller than 90°. When the contact angle is greater than 90° (i.e., when the concentration of ethanol<15 vol %), the cavities stay more or less dry because the Laplace pressure (∇P), determined from the Young-Laplace equation (∇P=2σc where c is the mean curvature of the cavity interface), is greater than 1 atm; thus, the ethanol-water mixtures are not favorable to fill the cavities under ambient conditions. Once the contact angle becomes less than 90°, the liquid mixture is able to wet the surface and fill the cavities. The abrupt change in the transmittance intensity is visible to the naked eye. Appreciable changes in the transmittance spectra are observed when the concentration of ethanol is raised above 5 vol %, likely (but without being bound to any particular theory) due to enhanced wetting within the cavities. Given that the cavities are being partially filled with addition of ethanol, it is likely (though without being bound to any particular theory) that homogenous solution of water and ethanol rather than pure ethanol is filling the cavities, inducing the spectral changes. To facilitate re-use of these Bragg reflectors, the liquid can be dried and removed from the cavities. In addition to ethanol, the Bragg reflector can detect the presence of other water-soluble chemical compounds such as dimethyl sulfoxide and acetonitrile that have favorable wetting on PS (FIG. 14). These results show that the Bragg reflector fabricated using our method can detect the presence of organic solvents, contaminants and toxins that are miscible with water.

### CONCLUSION

In summary, we have successfully fabricated PINFs with high-volume fraction of NPs (>60 vol %) by inducing CaRI with inorganic and polymer NPs, which enables the scalable fabrication of homogenous or heterostructure PINFs. When a bilayer with polymer NP bottom layer and inorganic NP top layer (SiO₂/PS bilayer in this work) is annealed, a double stack structure with cavities in the bottom layer is produced. In addition to enabling the formation of cavities at moderate temperatures (<200° C.), this method also eliminates the use of organic solvents in the preparation of the initial bilayer structure, making the process environmentally friendly and energy efficient. Due to a large difference in the refractive indices of the top and bottom layers in these double stack PINFs, they can be used for the fabrication of Bragg reflectors that can detect the presence of wetting agents in water. This eco-friendly and controllable technique is of great use to fabricate PINFs for a variety of applications in addition to photonics, including membrane separations and drug delivery.

### EXPERIMENTAL SECTION

Materials

SiO₂NPs with diameter of 26 nm (Ludox® TM-50, 50 wt % suspension) are purchased from MilliporeSigma (St. Louis, Mo.) and SiO₂ NPs with diameter of 112±30 nm (Snowtex® ST-ZL, 40 wt % suspension) are obtained from Nissan Chemical America Corp. (Houston, Tex.); non-crosslinked PS NPs with diameter of 100 nm (S37204, 8% w/v suspension) are purchased from Invitrogen (Carlsbad, Calif.) and non-crosslinked PS NPs with diameter of 1 μm (PSO4N, 10.01 wt % suspension) are obtained from Bangs Laboratories, Inc. (Fishers, Ind.).

### Preparation of the Bilayers and Inducing Capillary Rise Infiltration (CaRI)

To prepare substrates prior to the bilayer deposition, silicon wafers or glass slides are cut into 1.5×1.5 cm² and then rinsed with isopropyl alcohol (certified ACS plus, Fisher Scientific, Hampton, N.H.) and DI water. The substrates are treated with oxygen plasma for 2 min just before they are used.

To prepare bilayers via spin coating, the stock dispersions are diluted with DI water to appropriate concentrations (15 wt % and 11 wt % for 26 nm SiO₂ NP dispersion, 23 wt % of the 112±30 nm SiO₂ NP dispersion and 4% w/v for 100 nm PS dispersion) and then sonicated for 2 hr (except for the PS dispersion), followed by filtering using syringe filters with cutoff of 450 nm. The diluted and filtered dispersions are sequentially coated onto the substrates via a spin coater (WS-400BZ-6NPP/Lite, Laurell Technologies Corporation, North Wales, Pa.). Thickness of each layer is controlled by changing rotation speed. PS NP layers are oxygen plasma treated for 5 sec to render them hydrophilic to facilitate spin coating of SiO₂ NPs.

To deposit the initial bilayer via blade coating, a mixed dispersion containing 26 nm SiO₂ NP (12 vol %) and 100 nm PS (4% w/v) NP is coated via a custom designed blade coater using a glass slide as the blade. Details about the blade coater can be found elsewhere. In our design, commercial adhesive tape (Scotch® Magic™, 3M, St. Paul, Minn.) is applied to both ends of the substrate to create a gap between the substrate and the blade. After a small volume (≈3 μL) of the mixture is placed between the substrate and the blade using a micropipette (0.5-10 μL, Eppendorf, Germany) the blade is moved at a rate of 2 mm sec⁻¹.

The prepared bilayers are thermally annealed for 3 hr in an oven (Model 20 Lab Oven, Quincy Lab, Inc, South Beloit, Ill.) maintained at 180° C. To monitor the CaRI process in situ, a heating stage (Linkam THMS350V, UK) with a temperature resolution of 0.1° C. is used.

Characterization of CaRI PINFs

Before and after annealing, thickness and refractive index of the bilayers are obtained using a spectroscopic ellipsometer (Alpha-SE, J. A. Woollam, Lincoln, Nebr.). The optical data, amplitude ratio and phase difference, are collected in the range of λ=380-900 nm at an incident angle of 70°, and interpreted using CompleteEASE. Each layer can be described using the Cauchy model, n(λ)=A+B/λ²+C/λ⁴, where A, B, and C are optical constants. All the Cauchy modeling is performed with low mean square errors (<10). For in situ monitoring, the heating stage is mounted on the ellipsometer, and the data is collected in situ at 140° C.

The top-down and cross-section images of the films are taken using a scanning electron microscope (JSM-7500F, JEOL, Japan) under the condition of 5 kV accelerating voltage and 20 μA emission current. Prior to imaging, 4 nm iridium layer is sputtered via a sputter coater (Q150T ES, Quorum, UK) to prevent charging.

Transmittance spectra of the Bragg reflectors (prepared on slide glasses) are acquired using a spectrophotometer (Cary 5000 UV-Vis-NIR, Agilent, Santa Clara, Calif.) in the range of λ=380-800 nm. In every measurement, transmittance of a blank glass slide is used as the baseline to eliminate the influence of the substrate. For transmittance spectra of the Bragg reflectors in the mixture of water and ethanol (200 Proof, Decon Labs, King of Prussia, Pa.), a different spectrophotometer (Infinite M200, Tecan, Switzerland) that allows cell culture plates is used to hold liquid media. Each Bragg reflector is placed in each well of a 6-well cell culture plate (Costar® 3516, Corning Incorporated, Kennebunk, Me.), and 3 mL of the mixtures with different compositions are added using a micropipette (100-1000 uL, Eppendorf, Germany).

Designing the Thicknesses of PS and SiO₂ NP Layers to Meet α≈1

The thickness of the PS NP layer is difficult to adjust in small increments because of the size of PS NPs (100 nm). Thus, we keep the PS NP layer as a monolayer and adjust the thickness of the SiO₂ NP layer. The volume of each constituent in each layer is a product of the volume fraction (ϕ) of the constituent, the cross-section area (S) of the layer and the height (H) of the layer. Spectroscopic ellipsometry gives H and n of the layers (n_{layer}), and ϕ can be subsequently extracted from n_{layer} using Equation (S1) that expresses n_{layer} as a simple sum of n×ϕ for each constituent,

n_{layer}=n₁×ϕ₁+n₂×ϕ₂,+n₃×ϕ₃ . . . , (ϕ₁+ϕ₂ϕ₃. . . =1). (S1)

(PS/SiO₂) Bilayer

The refractive index of the SiO₂ NP layer is 1.31, regardless of H and other coating conditions. Considering that the SiO₂ NP layer is a binary system of SiO₂ NPs (n≈1.46) and air (n≈1.00), Equation (S1) yields ϕₐᵢᵣ ≈32 vol % (ϕ_{SiO2}≈68 vol %). Accordingly, the volume of the air (nanopores) in the SiO₂ layers can be expressed as 32 vol %×S×H_{SiO2}.

The refractive index of the PS NP layer (H_{PS}≈100 nm) deposited on the SiO₂ NP layer is 1.28. The PS NP layer is also a binary system composed of PS NPs (n≈1.59) and air (n≈1.00), and accordingly Equation (S1) yields ϕ_{PS}≈48 vol %. The volume of the PS NPs can be expressed as 48 vol %×S×100 nm³. Based on these estimates, to satisfy α=1, H_{SiO2} should be 150 nm.

(SiO₂/PS) Bilayer

The refractive index of the PS NP layer (H_{PS}≈100 nm) deposited on a silicon wafer is 1.29, which gives ϕ_{PS}≈50 vol % according to Equation (S1). Thus, the volume of PS NPs can be expressed as 50 vol %×S×100 nm³.

After SiO₂ NPs infiltrates into the voids between PS NPs, the refractive index of the PS NP layer jumps up to 1.42. Considering refractive indices before and after the infiltration of the SiO₂ NPs, Equation (S1) yields ϕ_{PS}≈48 vol %, ϕ_{SiO2}≤28 vol % and ϕₐᵢᵣ ≈22 vol %. ϕₐᵢᵣ in the SiO₂ NP layer is ≈32 vol %, and thus the total volume of air in the bilayer can be expressed as (22 vol %×S×100)+(32 vol %×S×H_{SiO2}). To satisfy α=1, H_{SiO2} should be 90 nm.

### GLOSSARY

(SiO₂/PS) SiO₂ NP layer atop PS NP layer
(PS/SiO₂) PS NP layer atop SiO₂ NP layer
a particle radius
c mean curvature
CaRI capillary rise infiltration
D diffusion constant
h capillary rise height
H dispersion height
k_{B} Boltzmann constant
n refractive index
N number of layers
NP nanoparticle
Pe Peclet number
PINF polymer-infiltrated nanoparticle film
PS polystyrene
r mean porous radius
R reflectance band
SIP solvent-driven infiltration of polymer
Si silicon
SEM scanning electron microscopy
t time
T temperature
T_{g} glass transition temperature
vₑᵥ evaporation rate
α the volume of PS NPs over that of the interstitial voids in the SiO₂ layer
η dynamic viscosity
θ_{ca} contact angle
λ wavelength
σ surface tension
τ tortuosity
ϕ volume fraction
ΔP Laplace pressure

### EMBODIMENTS

The following Embodiments are illustrative only and do not limit the scope of the present disclosure or the appended claims.

Embodiment 1. A heterostructured film having a thickness, comprising:

at least one section (which can be a repeat unit), the at least one section comprising a first region defined along the direction of the thickness,

the first region comprising a plurality of cavities therein, the cavities being defined between struts that comprise template particles having interstitial spaces therebetween that are infiltrated by a filler polymer having a glass transition temperature or a melting temperature, and

a second region defined along the direction of the thickness, the second region being adjacent to the first region, and the second region being formed of template particles having interstitial spaces therebetween that are infiltrated by the filler polymer.

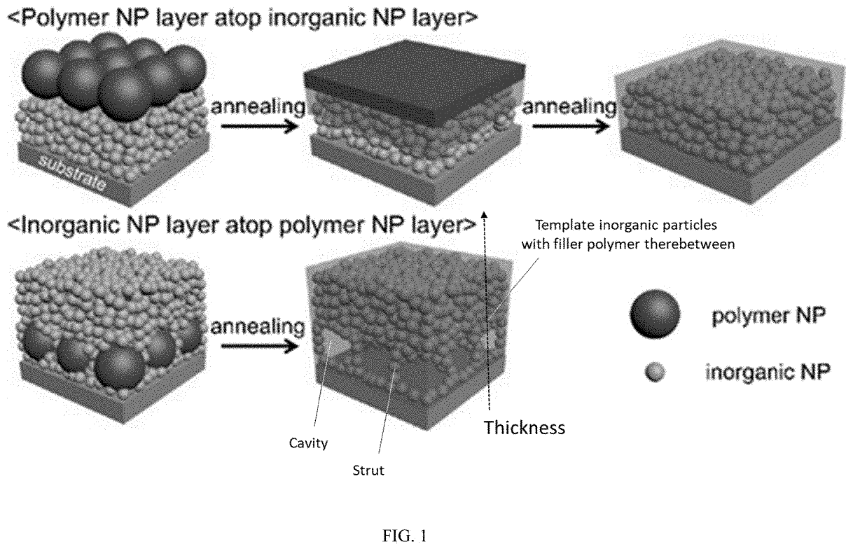

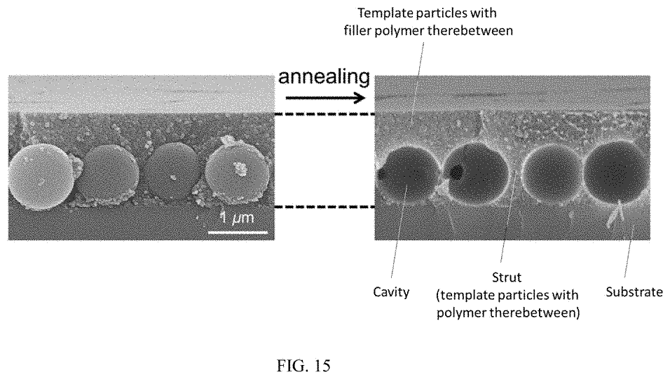

An example such film is shown in the lower right panel of FIG. 1. As shown, a film can include a plurality of cavities, which cavities can be some or all of the space initially occupied by the polymeric nanoparticles of the film. As shown, struts (that comprise inorganic nanoparticles) can be present between the polymeric nanoparticles, which struts can (following annealing) comprise the polymer of the polymeric nanoparticles and the inorganic nanoparticles. Also as shown, a film can comprise a region that includes the inorganic nanoparticles infiltrated with the polymer of the polymeric nanoparticles. In this way, a film according to the present disclosure can include regions (e.g., regions at different locations along the thickness of the film) that exhibit different refractive indices. Another illustration is provided in FIG. 15, which illustrates the formation of struts and cavities.

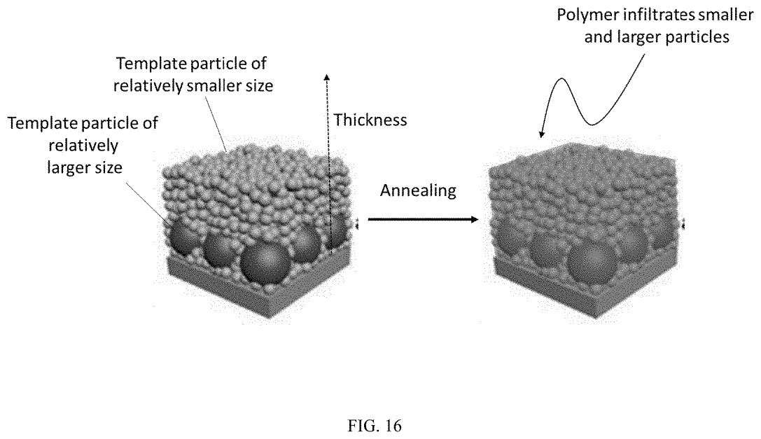

It should be understood that a film can also comprise, (i) at a first location along the thickness of the film, a region that is comparatively rich in nanoparticles of a first size, and (ii) at a second location along the thickness of the film, a region that is comparatively rich in nanoparticles of a second size. The film can, as shown in FIG. 16, include a filler polymer that infiltrates within the different regions of the film, thereby giving rise to a film that includes, along its thickness, regions of differently sized and/or differently composed nanoparticles. The source of the filler polymer can be nanoparticles (not shown in FIG. 16) that include the filler polymer; the filler polymer can also be introduced from a source exterior to the film. Without being bound to any particular theory or embodiment, the nanoparticles of the film can have a glass transition temperature or melting temperature that is higher than the glass transition or melting temperature of the infiltrating polymer.

The glass transition temperature or a melting temperature can be, e.g., less than about 200 deg. C., e.g., from about 100 to about 200 deg. C., from about 110 to about 190 deg. C., from about 120 to about 180 deg. C., from about 130 to about 170 deg. C., from about 140 to about 160 deg. C., or even about 150 deg. C. The glass transition temperature or a melting temperature of the polymeric particles can be lower than a temperature at which the template particles degrade or deform.

As described elsewhere herein, the polymeric particles can be a thermoplastic. Example thermoplastics include, without limitation, acrylics, ABS, nylon, polylactic acid, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, polyvinylidene fluoride, and polytetrafluoroethylene.

Template particles can be, e.g., inorganic particles such as alumina, SiO₂ and TiO₂. It should be understood, however, that template particles can also themselves be polymeric, e.g., a polymer that has a higher glass transition temperature and/or melting temperature than that of the polymeric particles. A template particle can also be a thermosetting polymer. A template particle can be of a material (which can be inorganic but can also be organic) having a comparatively high melting or glass transition temperature such that the template particle does not deform or degrade while the polymer of the polymeric particles undergoes infiltration during a thermal annealing.

The first region (which can be considered a layer in some configurations) that includes the cavities can have a refractive index that is lower than the refractive index of the second region (which can be considered a layer in some configurations). The difference can be, e.g., from about 1% to about 100%, from about 2% to about 80%, from about 3% to about 70%, from about 4% to about 60%, from about 6% to about 50%, from about 7% to about 40%, from about 8% to about 30%, or from about 10% to about 25%. The difference can also be, e.g., from about 0.1 to about 20%, from about 0.2 to about 15%, from about 0.3 to about 14%, from about 0.4 to about 13%, from about 0.5 to about 12%, from about 0.6 to about 10%, from about 0.7 to about 8%, from about 0.8 to about 7%, from about 0.9 to about 6%, or from about 1 to about 5%. The difference can be measured relative to the refractive index of the second region, e.g., when the refractive index of the second portion is 1.0 and the refractive index of the first portion is 0.95, the difference is 5%. By reference to the right-hand image in FIG. 2B, the difference in refractive indices is ((1.50-1.26)/1.50)=0.16 (i.e., 16%).

The present disclosure also contemplates the difference in refractive index achieved by annealing, i.e., the difference realized by forming the cavities in the first portion of the film. By reference to the example embodiment in FIG. 2B, the refractive index of the first portion changes from 1.42 to 1.26 following annealing. This is an example only, and the present disclosure contemplates refractive index changes realized by annealing of from, e.g., from about 1% to about 100%, from about 2% to about 80%, from about 3% to about 70%, from about 4% to about 60%, from about 6% to about 50%, from about 7% to about 40%, from about 8% to about 30%, or from about 10% to about 25%. The difference can also be, e.g., from about 0.1 to about 20%, from about 0.2 to about 15%, from about 0.3 to about 14%, from about 0.4 to about 13%, from about 0.5 to about 12%, from about 0.6 to about 10%, from about 0.7 to about 8%, from about 0.8 to about 7%, from about 0.9 to about 6%, or from about 1 to about 5%. By reference to the embodiment in FIG. 2B, the change in refractive index is ((1.42-1.26)/1.42)=11.2%.

Embodiment 2. The heterostructured film of Embodiment 1, wherein the cavities define an average cross-sectional dimension, wherein the template particles define an average cross-sectional dimension, and the average cross-sectional dimension of the cavities is greater than the average cross-sectional dimension of the template particles.

Embodiment 3. The heterostructured film of Embodiment 2, wherein the average cross-sectional dimension of the template particles is less than about 30% of the average cross-sectional dimension of the cavities.

Embodiment 4. The heterostructured film of any one of Embodiments 1-3, wherein the filler polymer comprises a thermoplastic. Polystyrene and polymethylmethacrylate are considered suitable thermoplastics.

Embodiment 5. The heterostructured film of any one of Embodiments 1-4, wherein the template particles comprise inorganic particles, e.g., silica, titania, alumina. As described elsewhere herein, however, template particles can also themselves be polymeric, e.g., a polymer that has a higher glass transition temperature and/or melting temperature than that of the polymeric particles. A template particle can also be a thermosetting polymer. A template particle can be formed of material (inorganic or organic) that has a comparatively high melting or glass transition temperature such that the template particle does not deform or degrade (or appreciably do so) while the polymer of the polymeric particles undergoes infiltration between the template particles during a thermal annealing.

Embodiment 6. The heterostructured film of any one of Embodiments 1-5, wherein the second region defines a thickness in the range of from about 1 layer of template particles to 1000 layers of template particles, e.g., from 1 layer to 1000 layers, from 2 layers to 500 layers, from 3 layers to 250 layers, from 4 layers to 200 layers, from 5 layers to 150 layers, from 5 layers to 100 layers, or even from 6 layers to 75 layers.

Embodiment 7. The heterostructured film of Embodiment 6, further comprising a plurality of sections units adjacent to one another. In this way, the film can, for example, comprise a stack of sections present as repeat units, which stacked repeat units can give rise to a user's desired functionality.

Embodiment 8. A Bragg reflector, the Bragg reflector comprising a heterostructured film according to any one of Embodiments 1-7.

Embodiment 9. A layered composition, comprising:

a first layer of polymeric particles, the polymeric particles optionally being disposed in a liquid dispersion, the polymeric particles defining an average cross-sectional dimension and having a glass transition temperature or a melting temperature; and

a first layer of template particles, the template particles optionally being inorganic particles, the template particles optionally being disposed in a liquid dispersion, the template particles defining interstitial voids therebetween, the template particles defining an average cross-sectional dimension that is less than the average cross-sectional dimension of the polymeric particles, and the first layer of template particles optionally being disposed atop the first layer of polymeric particles.

Embodiment 10. The layered composition of Embodiment 9, wherein the average cross-sectional dimension of the polymeric particles is in the range of from about 5 nm to about 10,000 nm. As some examples, the average cross-sectional dimension can be in the range of from, e.g., about 5 to about 10,000 nm, from about 6 to about 5,000 nm, from about 7 to about 2,500 nm, from about 10 to about 2,000 nm, from about 15 to about 1,500 nm, from about 20 to about 1,000 nm, from about 25 to about 750 nm, from about 30 to about 500 nm, from about 35 to about 250 nm, from about 40 to about 200 nm, or even from about 45 to about 175 nm.

Embodiment 11. The layered composition of any one of Embodiments 9-10, wherein the average cross-sectional dimension of the template particles is in the range of from about 1 nm to about 1000 nm. As some examples, the average cross-sectional dimension of the template particles can be from about 1 to about 1000 nm, from about 3 to about 750 nm, from about 5 to about 650 nm, from about 7 to about 600 nm, from about 8 to about 550 nm, from about 10 to about 450 nm, from about 12 to about 400 nm, from about 15 to about 350 nm, from about 20 to about 320 nm, from about 25 to about 300 nm, from about 28 to about 275 nm, from about 30 to about 260 nm, from about 35 to about 230 nm, from about 40 to about 210 nm, from about 50 to about 175 nm, from about 75 to about 150 nm, or even from about 80 to about 110 nm.

Embodiment 12. The layered composition of Embodiment 10, wherein the average cross-sectional dimension of the template particles is less than about 30%, less than about 27%, less than about 24%, less than about 21%, less than about 18%, less than about 15%, less than about 12%, less than about 9%, or even less than about 6% of the average cross-sectional dimension of the polymeric particles.

Embodiment 13. The layered composition of any one of Embodiments 9-12, wherein the glass transition temperature or melting temperature of the polymeric particles is lower than a glass transition temperature or melting temperature of the template particles.

Embodiment 14. The layered composition of any one of Embodiments 9-13, wherein a fill ratio is defined as the ratio of the volume of the polymeric particles in the first layer to the volume of the interstitial voids of the template particles, and the fill ratio of the layered composition is from about 0.1 to about 2, e.g., from about 0.1 to about 2, from about 0.2 to about 1.9, from about 0.3 to about 1.8, from about 0.4 to about 1.7, from about 0.5 to about 1.6, from about 0.6 to about 1.5, from about 0.7 to about 1.4, from about 0.8 to about 1.3, from about 0.9 to about 1.2, or from about 1 to about 1.1.

Embodiment 15. The layered composition of Embodiment 14, wherein the fill ratio is between about 0.9 and about 1.1.

Embodiment 16. The layered composition of Embodiment 15, wherein the fill ratio is about 1.

Embodiment 17. The layered composition of any one of Embodiments 9-16, further comprising a second layer of template particles, the second layer of template particles being adjacent to the first layer of polymeric particles. The second layer of template particles can be the same type of template particles as are in the first layer of template particles, but this is not a requirement, as the second layer of template particles can comprise particles that differ in some aspect (e.g., size, material) from the particles of the first layer of template particles.

Embodiment 18. The layered composition of Embodiment 17, further comprising a second layer of polymeric particles, the second layer of polymeric particles being adjacent to the second layer of template particles.

Embodiment 19. A method, comprising:

annealing a layered composition according to any one of Embodiments 9-18 at a temperature above the glass transition temperature or the melting temperature of the polymer particles such that polymer of the polymer particles infiltrates into the interstitial voids between the template particles so as to give rise to a film having a thickness and the film being characterized as homogeneous along the direction of the thickness. Such a film is shown in, e.g., FIG. 2A.

Embodiment 20. A method, comprising:

annealing a layered composition according to any one of Embodiments 9-18 at a temperature above the glass transition temperature or the melting temperature of the polymer particles such that polymer of the polymer particles infiltrates into the interstitial voids between the template particles so as to give rise to a film having a thickness and the film being characterized as heterogeneous along the direction of the thickness,

the film defining a first region along the direction of the thickness, the first region being polymer of the polymeric particles,

the film defining a second region along the direction of the thickness, the second region adjacent to the first region and the second region being template particles having interstitial spaces therebetween that are infiltrated by the polymer of the polymeric particles, and

the film defining a third region along the direction of the thickness, the third region being adjacent to the second region and the third region being template particles. Such a film can be characterized as a trilayer film.

Embodiment 21. A method, comprising:

annealing a layered composition according to any one of Embodiments 9-18 at a temperature above the glass transition temperature or the melting temperature of the polymer particles such that polymer of the polymer particles infiltrates into the interstitial voids between the template particles so as to give rise to a film having a thickness and the film being characterized as heterogeneous along the direction of the thickness,

the film defining a first region along the direction of the thickness,

the first region comprising a plurality of cavities therein,

the cavities being generally located at locations occupied by the polymer particles before annealing and the cavities being defined between struts comprising template particles having interstitial spaces therebetween that are infiltrated by the polymer of the polymeric particles,

the film defining a second region along the direction of the thickness,

the second region adjacent to the first region and the second region being template particles having interstitial spaces therebetween that are infiltrated by the polymer of the polymeric particles.

Embodiment 22. A homogeneous film made according to Embodiment 19.

Embodiment 23. A heterogeneous film made according to any one of Embodiments 20-21.

Embodiment 24. A method, comprising:

with

(a) a layer of template particles,

the template particles optionally being inorganic particles, the template particles optionally being disposed in a liquid dispersion, the template particles defining interstitial voids therebetween, and the template particles defining an average cross-sectional dimension that is less than the average cross-sectional dimension of the polymeric particles, and

(b) a layer of polymeric particles,

the polymeric particles optionally being disposed in a liquid dispersion, the polymeric particles defining an average cross-sectional dimension and having a glass transition temperature or a melting temperature, and the layer of polymeric particles being located adjacent to and beneath the layer of template particles;

annealing the layer of polymeric particles so as to give rise to a heterostructured film having a thickness,

the heterostructured film defining a first region along the direction of the thickness,

the first region comprising a plurality of cavities therein, the cavities being generally located at locations occupied by the polymer particles before annealing the polymeric particles and the cavities being defined between struts comprising template particles having interstitial spaces therebetween that are infiltrated by the polymer of the polymeric particles,

the heterostructured film defining a second region along the direction of the thickness,

the second region adjacent to the first region, and the second region comprising template particles having interstitial spaces therebetween that are infiltrated by the polymer of the polymeric particles.

Embodiment 25. A method, comprising:

dispersing a mixture of (i) polymeric particles having a glass transition temperature or a melting temperature and (ii) template particles in an evaporative medium across a substrate,

the dispersing being performed under such conditions that evaporation of the evaporative medium gives rise to stratification between the template particles and polymeric particles such that the polymeric particles form a lower layer atop which the template particles form an upper layer; and

annealing the lower layer and the upper layer so as to give rise to a film having a thickness and the film being characterized as heterogeneous along the direction of the thickness,

the film defining a first region along the direction of the thickness,

the first region comprising a plurality of cavities therein, the cavities being generally located at locations occupied by the polymer particles before annealing and the cavities being defined between struts comprising template particles having interstitial spaces therebetween that are infiltrated by the polymer of the polymeric particles,

the film defining a second region along the direction of the thickness,

the second region adjacent to the first region and

the second region being template particles having interstitial spaces therebetween that are infiltrated by the polymer of the polymeric particles.

The present disclosure also includes, e.g., optical filters that include a film according to the present disclosure. Such a filter can be comprised in, e.g., a sensor device that receives light that has been filtered by the film. Such a filter can also be comprised in, e.g., a transmitter, which transmitter emits light that is filtered by the film.

### REFERENCES

Y. R. Huang, Y. Jiang, J. L. Hor, R. Gupta, L. Zhang, K. J. Stebe, G. Feng, K. T. Turner, D. Lee, Nanoscale 2015, 7, 798.
J. L. Hor, Y. Jiang, D. J. Ring, R. A. Riggleman, K. T. Turner, D. Lee, ACS Nano 2017, 11, 3229.
Y. Jiang, J. L. Hor, D. Lee, K. T. Turner, ACS Appl. Mater. Interfaces 2018, 10, 44011.
N. Manohar, K. J. Stebe, D. Lee, ACS Macro Lett. 2017, 6, 1104.
Q. Chen, S. Gong, J. Moll, D. Zhao, S. K. Kumar, R. H. Colby, ACS Macro Lett. 2015, 4, 398.
P. E. de Jongh, T. M. Eggenhuisen, Adv. Mater. 2013, 25, 6672.
S. Flauder, R. Sajzew, F. A. Müller, ACS Appl. Mater. Interfaces 2015, 7, 845.
Z. Gemici, P. I. Schwachulla, E. H. Williamson, M. F. Rubner, R. E. Cohen, Nano Lett. 2009, 9, 1064.
D. W. Wang, F. Li, J. Zhao, W. Ren, Z. G. Chen, J. Tan, Z. S. Wu, I. Gentle, G. Q. Lu, H. M. Cheng, ACS Nano 2009, 3, 1745.
Q. Lan, N. Yan, Y. Wang, J. Memb. Sci. 2017, 533, 96.
H. H. Tran, R. B. Venkatesh, Y. Kim, D. Lee, D. Riassetto, Nanoscale 2019, 11, 22099.
J. P L, H. Nallabothula, A. V. Menon, S. Bose, ACS Appl. Nano Mater. 2020, 3, 1872.
E. Bakangura, L. Wu, L. Ge, Z. Yang, T. Xu, Prog. Polym. Sci. 2016, 57, 103.
X. Zeng, S. Xu, P. Pi, J. Cheng, L. Wang, S. Wang, X. Wen, J. Mater. Sci. 2018, 53, 10554.
H. Zhang, M. Popp, A. Hartwig, L. Madler, Nanoscale 2012, 4, 2326.
E. Landi, F. Valentini, A. Tampieri, Acta Biomater. 2008, 4, 1620.
J. Hiller, J. D. Mendelsohn, M. F. Rubner, Nat. Mater. 2002, 1, 59.
X. B. Shi, Y. Hu, B. Wang, L. Zhang, Z. K. Wang, L. S. Liao, Adv. Mater. 2015, 27, 6696.
D. P. Song, C. Li, W. Li, J. J. Watkins, ACS Nano 2016, 10, 1216.
K. V. Peinemann, V. Abetz, P. F. W. Simon, Nat. Mater. 2007, 6, 992.
W. Deibert, M. E. Ivanova, W. A. Meulenberg, R. Vaβen, O. Guillon, J. Memb. Sci. 2015, 492, 439.
M. C. Berg, L. Zhai, R. E. Cohen, M. F. Rubner, Biomacromolecules 2006, 7, 357.
J. L. Hor, H. Wang, Z. Fakhraai, D. Lee, Soft Matter 2018, 14, 2438.
M. Le Berre, Y. Chen, D. Baigl, Langmuir 2009, 25, 2554.
R. E. Trueman, E. Lago Domingues, S. N. Emmett, M. W. Murray, A. F. Routh, J. Colloid Interface Sci. 2012, 377, 207.
A. F. Routh, Reports Prog. Phys. 2013, 76, 046603.
A. Fortini, I. Martin-Fabiani, J. L. De La Haye, P. Y. Dugas, M. Lansalot, F. D'Agosto, E. Bourgeat-Lami, J. L. Keddie, R. P. Sear, Phys. Rev. Lett. 2016, 116, 118301.
J. Zhou, Y. Jiang, M. Doi, Phys. Rev. Lett. 2017, 118, 108002.
M. Schulz, J. L. Keddie, Soft Matter 2018, 14, 6181.
N. Fries, M. Dreyer, J. Colloid Interface Sci. 2008, 320, 259.
J. L. Hor, H. Wang, Z. Fakhraai, D. Lee, Macromolecules 2018, 51, 5069.
P. Spinelli, M. A. Verschuuren, A. Polman, Nat. Commun. 2012, 3, 692.
B. V. Lotsch, G. A. Ozin, Adv. Mater. 2008, 20, 4079.
J. Liu, E. Redel, S. Walheim, Z. Wang, V. Oberst, J. Liu, S. Heissler, A. Welle, M. Moosmann, T. Scherer, M. Bruns, H. Gliemann, C. Wöll, Chem. Mater. 2015, 27, 1991.
P. Lova, G. Manfredi, L. Boarino, A. Comite, M. Laus, M. Patrini, F. Marabelli, C. Soci, D. Comoretto, ACS Photonics 2015, 2, 537.
S. Gao, X. Tang, S. Langner, A. Osvet, C. HarreiB, M. K. S. Barr, E. Spiecker, J. Bachmann, C. J. Brabec, K. Forberich, ACS Appl. Mater. Interfaces 2018, 10, 36398.
S. Colodrero, A. Mihi, L. Haggman, M. Ocafia, G. Boschloo, A. Hagfeldt, H. Miguez, Adv. Mater. 2009, 21, 764.
J. T. Park, J. H. Prosser, S. H. Ahn, S. J. Kim, J. H. Kim, D. Lee, Adv. Funct. Mater. 2013, 23, 2193.
J. M. Ziebarth, A. K. Saafir, S. Fan, M. D. McGehee, Adv. Funct. Mater. 2004, 14, 451.
T. Jakubczyk, H. Franke, T. Smoleńiski, M. Ściesiek, W. Pacuski, A. Golnik, R. Schmidt-Grund, M. Grundmann, C. Kruse, D. Hommel, P. Kossacki, ACS Nano 2014, 8, 9970.
Y. C. Chen, H. Yeh, C. J. Lee, W. H. Chang, ACS Appl. Mater. Interfaces 2018, 10, 16874.
Y. R. Huang, J. T. Park, J. H. Prosser, J. H. Kim, D. Lee, J. Mater. Chem. C 2014, 2, 3260.
E. Hecht, Optics, Pearson Addison-Wesley, Reading, M A, 2001.
Y. S. Yu, M. C. Wang, X. Huang, Sci. Rep. 2017, 7, 14118.
A. Mizerski, MATEC Web Conf. 2018, 247, 00064.
J. R. Dann, J. Colloid Interface Sci. 1970, 32, 302.
A. Giacomello, S. Meloni, M. Chinappi, C. M. Casciola, Langmuir 2012, 28, 10764.
M. Abkarian, A. B. Subramaniam, S. H. Kim, R. J. Larsen, S. M. Yang, H. A. Stone, Phys. Rev. Lett. 2007, 99, 188301.
S. Chan, S. R. Homer, P. M. Fauchet, B. L. Miller, J. Am. Chem. Soc. 2001, 123, 11797.
Y. Y. Li, F. Cunin, J. R. Link, T. Gao, R. E. Betts, S. H. Reiver, V. Chin, S. N. Bhatia, M. J. Sailor, Science 2003, 299, 2045.
N. Atthi, 0. U. Nimittrakoolchai, W. Jeamsaksiri, S. Supothina, C. Hruanun, A. Poyai, Songklanakarin J. Sci. Technol. 2009, 31, 331.

What is claimed:

1. A heterostructured film having a thickness, comprising:
at least one section, the at least section comprising
(a) a first region defined along the direction of the thickness,
the first region comprising a plurality of cavities therein,
the cavities being defined between struts that comprise template particles having interstitial spaces therebetween that are infiltrated by a filler polymer having a glass transition temperature or a melting temperature, and
(b) a second region defined along the direction of the thickness,
the second region being adjacent to the first region, and
the second region being formed of template particles having interstitial spaces therebetween that are infiltrated by the filler polymer.

2. The heterostructured film of claim 1, wherein the cavities define an average cross-sectional dimension, wherein the template particles define an average cross-sectional dimension, and the average cross-sectional dimension of the cavities is greater than the average cross-sectional dimension of the template particles.

3. The heterostructured film of claim 2, wherein the average cross-sectional dimension of the template particles is less than about 30% of the average cross-sectional dimension of the cavities.

4. The heterostructured film of claim 1, wherein the filler polymer comprises a thermoplastic.

5. The heterostructured film of claim 1, wherein the template particles comprise inorganic particles or polymeric particles.

6. The heterostructured film of claim 1, wherein the second region defines a thickness in the range of from about 1 layer of template particles to 1000 layers of template particles.

7. The heterostructured film of claim 6, further comprising a plurality of sections adjacent to one another.

8. A Bragg reflector, the Bragg reflector comprising a heterostructured film according to claim 1.

9. A layered composition, comprising:
a first layer of polymeric particles,
the polymeric particles optionally being disposed in a liquid dispersion,
the polymeric particles defining an average cross-sectional dimension and having a glass transition temperature or a melting temperature; and
a first layer of template particles,
the template particles optionally being inorganic particles,
the template particles optionally being disposed in a liquid dispersion,
the template particles defining interstitial voids therebetween,
the template particles defining an average cross-sectional dimension that is less than the average cross-sectional dimension of the polymeric particles, and
the first layer of template particles optionally being disposed atop the first layer of polymeric particles.

10. The layered composition of claim 9, wherein the average cross-sectional dimension of the polymeric particles is in the range of from about 5 nm to about 10,000 nm.

11. The layered composition of claim 9, wherein the average cross-sectional dimension of the template particles is in the range of from about 1 nm to about 1000 nm.

12. The layered composition of claim 10, wherein the average cross-sectional dimension of the template particles is less than about 30% of the average cross-sectional dimension of the polymeric particles.

13. The layered composition of claim 9, wherein the glass transition temperature or melting temperature of the polymeric particles is lower than a glass transition temperature or melting temperature of the template particles.

14. The layered composition of claim 9, wherein a fill ratio is defined as the ratio of the volume of the polymeric particles in the first layer to the volume of the interstitial voids of the template particles, and the fill ratio of the layered composition is from about 0.1 to about 2.

15. The layered composition of claim 14, wherein the fill ratio is between about 0.9 and about 1.1.

16. The layered composition of claim 15, wherein the fill ratio is about 1.

17. The layered composition of claim 9, further comprising a second layer of template particles, the second layer of template particles being adjacent to the first layer of polymeric particles.

18. The layered composition of claim 17, further comprising a second layer of polymeric particles, the second layer of polymeric particles being adjacent to the second layer of template particles.

19. A method, comprising:
annealing a layered composition according to claim 9 at a temperature above the glass transition temperature or the melting temperature of the polymer particles such that polymer of the polymer particles infiltrates into the interstitial voids between the template particles so as to give rise to a film having a thickness. A method, comprising:
annealing a layered composition according to claim 9 at a temperature above the glass transition temperature or the melting temperature of the polymer particles such that polymer of the polymer particles infiltrates into the interstitial voids between the template particles so as to give rise to a film having a thickness and the film being characterized as heterogeneous along the direction of the thickness,
the film defining a first region along the direction of the thickness,
the first region comprising a plurality of cavities therein,
the cavities being generally located at locations occupied by the polymer particles before annealing and the cavities being defined between struts comprising template particles having interstitial spaces therebetween that are infiltrated by the polymer of the polymeric particles,
the film defining a second region along the direction of the thickness,
the second region adjacent to the first region and the second region being template particles having interstitial spaces therebetween that are infiltrated by the polymer of the polymeric particles.

20. A method, comprising:
with
(a) a layer of template particles,
the template particles optionally being inorganic particles,
the template particles optionally being disposed in a liquid dispersion,
the template particles defining interstitial voids therebetween, and
the template particles defining an average cross-sectional dimension that is less than the average cross-sectional dimension of the polymeric particles, and
(b) a layer of polymeric particles,
the polymeric particles optionally being disposed in a liquid dispersion,
the polymeric particles defining an average cross-sectional dimension and having a glass transition temperature or a melting temperature, and
the layer of polymeric particles being located adjacent to and beneath the layer of template particles;
annealing the layer of polymeric particles so as to give rise to a heterostructured film having a thickness,
the heterostructured film defining a first region along the direction of the thickness,
the first region comprising a plurality of cavities therein, the cavities being generally located at locations occupied by the polymer particles before annealing the polymeric particles and the cavities being defined between struts comprising template particles having interstitial spaces therebetween that are infiltrated by the polymer of the polymeric particles,
the heterostructured film defining a second region along the direction of the thickness,
the second region adjacent to the first region and the second region comprising template particles having interstitial spaces therebetween that are infiltrated by the polymer of the polymeric particles.
